(19) United States
(12) Patent Application Publication
(10) Pub. No.: US 2025/0341061 A1
(43) Pub. Date: Nov. 6, 2025

(54) MAT

(71) Applicant: Stephen Sperry, Parkland Bay, FL (US)

(72) Inventor: Stephen Sperry, Parkland Bay, FL (US)

(21) Appl. No.: 19/199,218

(22) Filed: May 5, 2025

Related U.S. Application Data
(60) Provisional application No. 63/643,104, filed on May 6, 2024.

(51) Int. Cl. E01C 9/08; B32B 7/022; B32B 21/08

(52) U.S. Cl. CPC E01C 9/086; B32B 7/022; B32B 21/08; B32B 2307/54; B32B 2307/712; B32B 2307/72

(57) ABSTRACT

A mat including a first outer layer comprising a plurality of first planks, the first planks comprising a first material having a first compressive strength and a first density, a second outer layer comprising a plurality of the first planks, at least one inner layer comprising a plurality of second planks disposed between the first and second outer layers, the second planks being disposed edge-to-edge next to each other, the second planks comprising a second material having a second compressive strength and a second density, the second density being lower than the first density, and a plurality of fasteners extending through the first outer layer, the at least one inner layer, and the second outer layer at predefined points.

### CROSS-REFERENCE TO RELATED APPLICATIONS

This application claims priority under 35 U.S.C. § 120 from U.S. Provisional Application No. 63/643,104, filed May 6, 2024 in the United States Patent and Trademark Office, the disclosure of which is incorporated herein in its entirety by reference.

### BACKGROUND

Construction projects and road work often require moving equipment and supplies over unfinished terrain, such as muddy road or ground recently cleared of trees. Unfortunately, heavy equipment such as bulldozers and cranes may become stuck in mud or damaged by driving over rocks and tree stumps. Standard practice therefore is to lay down “mats” to define a path to move equipment on. In many cases mats may be required by regulatory agencies to limit ground disturbance. Conventionally these mats are large panels made of layers of wooden boards attached to each other. Several mats placed alongside each other may make a solid surface for equipment to move over without becoming stuck or damaged by the terrain.

The outer layers of a mat serve as a point of contact, either with the ground or with the equipment driving over it. The inner layers of the mat stiffen the outer layers, preventing them from bending or deflecting excessively from the weight of the equipment being driven over them. Conventionally the inner layers are made of the same material, i.e. wood, as the outer layers, for ease of construction.

Conventional mats have several known problems. First is their thickness-mats used at a worksite preferably have a uniform thickness, so that they create a continuous surface without seams or sudden rises and falls that equipment may get stuck on. Accordingly, mats used at a worksite are preferably all the same construction and thickness. If there is a problem with the type of mat used, for example if there are not enough mats available, then additional layers or equipment changes may be needed to keep the surface height of all mats at a worksite uniform.

A second problem is the weight-mats are carried to a worksite on a truck and customarily offloaded by a forklift or similar lifting equipment to be put in place. Trucks and forklifts are only able to move so much weight at a time, and so heavier mats, for example thicker mats or mats made of denser materials, take more resources to move, since more trucks are required to move a given number of mats. Since heavier mats are customarily stronger than lighter mats, e.g. they may include additional layers and may be made of hardwood instead of softwood, then jobs requiring stronger mats require moving more weight, meaning these jobs have additional transportation costs over jobs using weaker, lighter mats.

Third, and connected to weight, is water absorption. Wood is a porous material, and so absorbs water. A mat that is used in a wet environment, for example mud or standing water, will absorb water and become heavier as it is used.

When a mat has absorbed water the inner layers typically take the longest to dry out, since they are sandwiched between the outer layers and so have the least exposure to air to help with evaporation. Often after mats are removed from a worksite, there is not enough time to let the inner layers dry before loading them onto trucks to take away. As such, someone carrying mats away after a job needs to move both the weight of the mats and the extra weight of the water absorbed by the mats. Since as noted above, trucks are limited in how much weight they can carry, water absorption may mean more trucks are needed to move mats away after a job than were needed to carry the mats to the job in the first place. As such, water absorption complicates logistics and adds extra cargo and transportation costs on to a job.

Still further, conventional mats may degrade the environment by absorbing water. When a mat absorbs mud, it also takes away soil from the worksite, which may cause erosion at the site, and furthermore may cause organic cross-contamination at the next job site.

Design of mats requires a balance between weight and strength. A mat must be strong enough to carry a defined load, for example the weight of a truck moving over it, without breaking. Conventionally mats may be made stronger by adding additional layers or using denser materials, e.g., boards made of oak instead of pine. However, adding layers or using denser materials increases the mat's weight.

There have been efforts to reduce the weight of a mat without compromising strength. A “hybrid” mat is one that uses hardwood as the outer layers, and one or more layers of softer, lighter wood between them. However, these hybrid mats are not preferable over conventional mats. Hybrid mats often do not handle weight as efficiently as a traditional mat made of entirely one kind of wood. Secondly, substituting one type of wood for another does not lead to significant weight savings. Furthermore, because the inner layers are still porous, they still absorb water, and so water absorption remains a problem. Finally, mats made of different materials may require special facilities to produce since the different materials may have different construction tolerances. This complexity can restrict availability and drive up costs of the hybrid mats.

Conventional mats save weight by including large voids in the middle layers, including gaps of up to eight inches between each board. Large voids like these reduce the amount of material used, thereby reducing weight. However, including voids like this still requires careful balance, since as noted above, the inner layers strengthen the outer layers to minimize deflection during use. Voids that are too large render the mat too flexible, i.e., the mat deflects too much during use. Excessive deflection can cause the wood to crack or the bolts holding the layers together to break or pop out, compromising the structural integrity of the mats. Furthermore, regardless of the size of any voids, the inner layers of a conventional mat will still absorb water and take on weight during use. Still further, voids act as places where mud or other debris may collect inside the mat, further increasing its weight without adding any additional strength.

### SUMMARY OF THE INVENTION

Exemplary embodiments of the present general inventive concept may provide a mat including outer layers and one or more inner layers having a lower density relative to the outer layers.

The foregoing and/or other features and utilities of the present general inventive concept may be achieved by providing a mat including a first outer layer comprising a plurality of first planks, the first planks comprising a first material having a first compressive strength and a first density, a second outer layer comprising a plurality of the first planks, at least one inner layer comprising a plurality of second planks disposed between the first and second outer layers, the second planks being disposed edge-to-edge next to each other, the second planks comprising a second material having a second compressive strength and a second density, the second density being lower than the first density, and a plurality of fasteners extending through the first outer layer, the at least one inner layer, and the second outer layer at predefined points.

In an exemplary embodiment, the first outer layer, the second outer layer, and the at least one inner layer may be configured to move relative to one another within a predefined limit.

In an exemplary embodiment, the second planks may be configured to move relative to each other within a predefined limit.

In an exemplary embodiment, the at least one inner layer may have a greater flexibility than the first outer layer or the second outer layer.

In an exemplary embodiment, the second material may be water-resistant.

In an exemplary embodiment, the second compressive strength may be less than the first compressive strength.

In an exemplary embodiment, the second compressive strength may be about equal to the first compressive strength.

In an exemplary embodiment, the second density may be between about 5 percent and about 50 percent of the first density.

In an exemplary embodiment, the plurality of second planks may be configured to avoid bonding with the plurality of fasteners.

In an exemplary embodiment, the plurality of second planks may be configured to move along a length of the plurality of fasteners.

In an exemplary embodiment, the first outer layer, second outer layer, and at least one inner layer may each have a predefined degree of flexibility.

In an exemplary embodiment, the second layer may further include one or more third planks comprising a third material, the third material having a third compressive strength and a third density, the third density being greater than the second density.

In an exemplary embodiment, the third material may be identical to the first material.

The foregoing and/or other features and utilities of the present general inventive concept may be achieved by providing a method of constructing a mat, the method including providing a first outer layer comprising a plurality of planks, the first planks comprising a first material having a first compressive strength and a first density, providing a second outer layer comprising a plurality of the first planks, providing at least one inner layer comprising a plurality of second planks disposed between the first and second outer layers, the second planks being disposed edge-to-edge next to each other, the second planks comprising a second material having a second compressive strength and a second density, the second density being lower than the first density, and inserting a plurality of fasteners through the first outer layer, the at least one inner layer, and the second outer layer at predefined points.

In an exemplary embodiment, the method may further include adjusting a flexibility of the mat by adjusting a tension in one or more of the plurality of fasteners.

In an exemplary embodiment, the method may further include adjusting a flexibility of the mat by adjusting a thickness of the at least one inner layer.

Additional features and utilities of the present general inventive concept will be set forth in part in the description which follows and, in part, will be obvious from the description, or may be learned by practice of the general inventive concept.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a perspective view of a mat according to an exemplary embodiment of the present general inventive concept;

FIG. 2 is a top view of a mat according to an exemplary embodiment of the present general inventive concept;

FIG. 3 is a side cross-sectional view of a mat and fasteners according to an exemplary embodiment of the present general inventive concept;

FIG. 4A is a cross-sectional view of load distribution in a mat without voids according to an exemplary embodiment of the present general inventive concept;

FIG. 4B is a cross-sectional view of load distribution in a mat with a void according to an exemplary embodiment of the present general inventive concept;

FIGS. 5A-5C are views of an inner layer according to exemplary embodiments of the present general inventive concept; and

FIG. 6 is a cross-sectional side view of a mat under deflection according to an exemplary embodiment of the present general inventive concept.

### DETAILED DESCRIPTION OF EXEMPLARY EMBODIMENTS OF THE INVENTIVE CONCEPT

Reference will now be made in detail to embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, certain terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Also, when a part “includes” or “comprises” an element, unless there is a particular description contrary thereto, the part can further include other elements, not excluding the other elements.

Hereinafter, one or more exemplary embodiments of the present general inventive concept will be described in detail with reference to accompanying drawings.

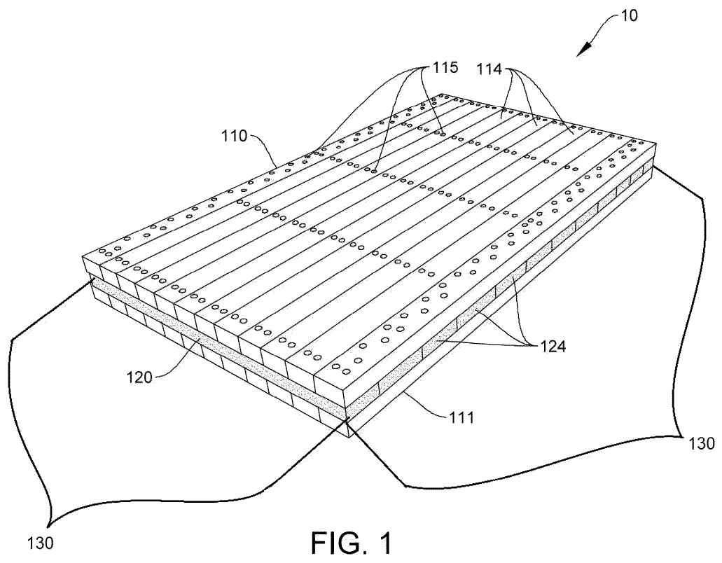

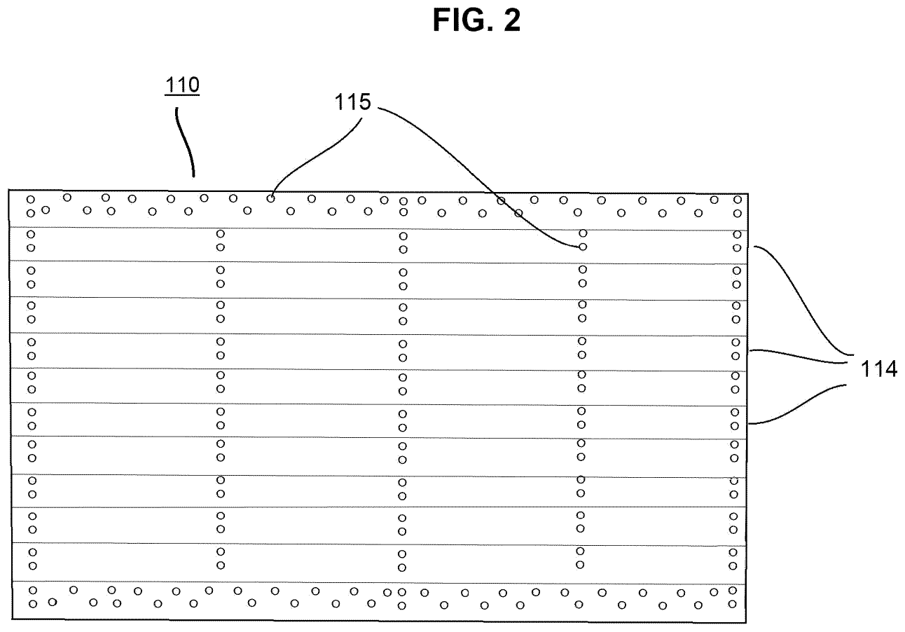

FIG. 1 is a perspective view of a mat 10 according to an exemplary embodiment of the present general inventive concept. Similarly, FIG. 2 is a top view of a mat 10 according to an exemplary embodiment of the present general inventive concept. As illustrated in FIG. 1, the mat 10 may include a first outer layer 110, a second outer layer 111, and one or more inner layers 120. A single inner layer 120 is illustrated in the FIG. 1, but it will be understood that any number of inner layers 120 may be included, stacked on top of one another, without departing from the present general inventive concept. The total number of inner layers 120 may be adjusted to make the mat 10 a desired total thickness, or to give it a desired flexibility, as discussed in detail below.

According to exemplary embodiments of the present general inventive concept, the first and second outer layers 110 and 111 may be made wholly or partially from a first material, for example a wood such as oak, or alternatively a flexible high-density foam. The first material may have a first compressive strength and a first density. For the purposes of this application, “compressive strength” may describe a material's resistance to compressive force, for example how well the material resists being crushed while supporting a load, such as from equipment driving over the mat 10. The first and second outer layers 110 and 111 may both be made of the first material and may be identical in construction, so that the mat 10 does not have a designated “top” or “bottom,” but rather can be used in the same way no matter which outer layer 110, 111 is facing up. As such, although FIG. 2 illustrates a top view showing the first outer layer 110, a view of the second outer layer 111 would be similar. Furthermore, it will be understood the first and second outer layer 110, 111 may include other materials in addition to the first material, for example metal plates or other reinforcement, according to different exemplary embodiments of the present general inventive concept.

According to exemplary embodiments of the present general inventive concept, the first and second outer layers 110 and 111 may have a length and width of a conventional mat, for example eight feet by fourteen feet. As illustrated for example in FIG. 1, the first and second outer layers 110 and 111 may be constructed of a plurality of first planks 114 made of the first material and arranged next to one another. The planks 114 may be a uniform cross-sectional dimension, such as a dimension of a conventional wooden board. For example, the first planks 114 may comprise 2×8 or 2×10 boards. It will be understood that a conventional 2×8 board has cross-sectional dimensions of 1.5″×7.25″, and that a conventional 2×10 board has cross-sectional dimensions of 1.5″×9.25″. Although the first planks 114 may be placed edge-to-edge as illustrated in FIGS. 1 and 2, according to exemplary embodiments of the present general inventive concept there may be spacing between the first planks 114, to account for warped or imperfect materials.

The inner layer(s) 120 may comprise a second material which has a second compressive strength and a second density, the second density being lower than the first density. The second material may also be water-resistant, to minimize the amount of water it absorbs when the mat 10 is in use. According to exemplary embodiments of the present general inventive concept, the second material may be a closed-cell foam such as extruded polypropylene. According to other exemplary embodiments of the present general inventive concept, the second material may be aluminum or other material formed in a honeycomb or other lightweight structure.

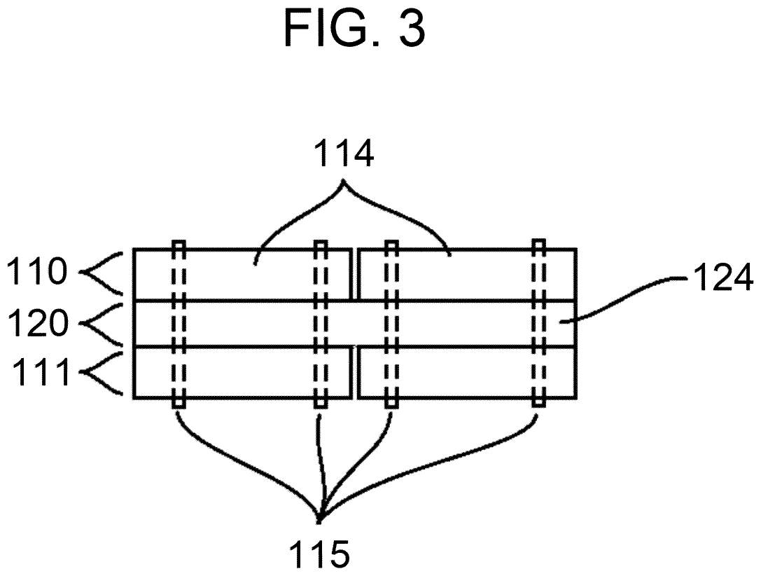

According to exemplary embodiments of the present general inventive concept, the inner layer(s) 120 may have a length and width about identical to the outer layers 110, 111, and may comprise a plurality of second planks 124, similarly to the outer layers 110, 111. As illustrated for example in FIGS. 1 and 3, The second planks 124 may be oriented perpendicular to the first planks 114 of the first and second layers 110, 111, such that when the first planks 114 of first and second outer layers 110, 111 are fastened to the second planks 124 of the inner layer(s) 120, the first planks 114 and second planks 124 may hold each other in place in the mat 10. If three or more inner layers 120 are used, the orientation of the planks 124 may be alternated on each inner layer 120, such that each inner layer 120 has planks 124 disposed perpendicular to an adjacent inner layer 120. A perimeter 130 of the inner layer(s) 120 may also be sealed, for example with an epoxy, glue, or rubber, to render the perimeter 130 more water-resistant and to strengthen the edges of the mat 10 against breaking under a load.

A thickness of the inner layer(s) 120, and resulting total thickness of the mat 10, may be set as desired according to the particular exemplary embodiment of the present general inventive concept. According to an exemplary embodiment of the present general inventive concept, second planks 124 of the inner layer(s) 120 may have a uniform thickness, for example a thickness about equal to a thickness of the first planks 114 of each of the outer layers 110, 111. According to other exemplary embodiments of the present general inventive concept, second planks 124 may have a different thickness than the first planks 114. A total thickness of the inner layers 120 may be adjusted by adding or removing individual inner layers 120. According to exemplary embodiments of the present general inventive concept, a total thickness of the inner layer(s) 120 may be set such that the mat 10 is about the same thickness as a conventional mat. According to these exemplary embodiments, the mat 10 may be used in conjunction with one or more conventional mats while maintaining a uniform surface height between mats. That is, the mat 10 may be used alongside conventional mats without creating rises or falls between mats or requiring additional layers or equipment changes.

FIG. 3 is a cross-sectional side view of the mat 10. As illustrated therein, the first planks 114 of outer layers 110 and 111 may be attached to the inner layer(s) 120 with a plurality of fasteners 115, for example screws, bolts, dowels, or any other structure with enough strength to attach the outer layers 110, 111 and the inner layer(s) 120 together. According to exemplary embodiments of the present general inventive concept, the fasteners 115 may extend through the first outer layer 110, through the inner layer(s) 120, and through the second outer layer 111 to connect these layers to each other. According to exemplary embodiments including a plurality of inner layers 120, the fasteners 115 may also attach a plurality of inner layers 120 to each other. In operation the layers 110, 111, and 120 would be held together by the fasteners 115, as shown for example in FIG. 3. According to exemplary embodiments of the present general inventive concept the fasteners 115 may extend fully or partially through the outer layers 110 and 111, i.e., they may protrude out of either or both of the top and bottom of the mat 10, or may not protrude, depending on the exemplary embodiment.

According to exemplary embodiments of the present general inventive concept, the fasteners 115 may be located only at discrete points on the layers 110, 111, and 120. For example, the fasteners 115 may be bolts or screws instead of, e.g., a tape or glue which would be applied to the entire area of the outer layers 110, 111 to bond them to the inner layer(s) 120. As illustrated for example in FIG. 1, the fasteners 115 may be bolts or screws located on first planks 114 along the perimeter of the mat 10 and at points along the first planks 114 of the outer layer 110. Outside of these points, the layers 110, 111, and 120 may not be directly bonded to each other. As such, the layers 110, 111, and 120 may be able to move relative to one another within a predetermined limit, which may give the mat 10 a predetermined degree of flexibility.

The second material of the inner layer(s) 120 may be screw-holding, meaning that it may have enough structural strength to support a fastener 115 which is screwed into it, i.e., it may support a screw's threads without breaking. According to exemplary embodiments of the present general inventive concept, a foam used as the second material may have a screw retention for a #10 screw between about 135 N and about 930 N. It will be understood that this range of screw retention is for example purposes, and is not intended to be limiting.

According to another exemplary embodiment of the present general inventive concept, the second material may not be screw-holding, and may instead be configured to avoid bonding with the fasteners 115. In these exemplary embodiments, the inner layer(s) 120 may move along the length of a fastener 115 extending through the mat 10. As a result the second planks 124 of the inner layer(s) 120 may be configured to move relative to the outer layers 110, 111, without building up shear stress around the fasteners 115 which otherwise may damage the inner layer(s) 120. For example, when the mat 10 is loaded with a weight, the inner layer(s) 120 may compress to a certain degree, reducing its overall thickness. If the inner layer(s) 120 can move along the fasteners 115, they may be compressed without building up shear strain around the fasteners 115. Similarly, if the mat 10 bends or deflects under a load, the inner layer(s) 120 may move along the fasteners 115 with the deflection, without building up strain.

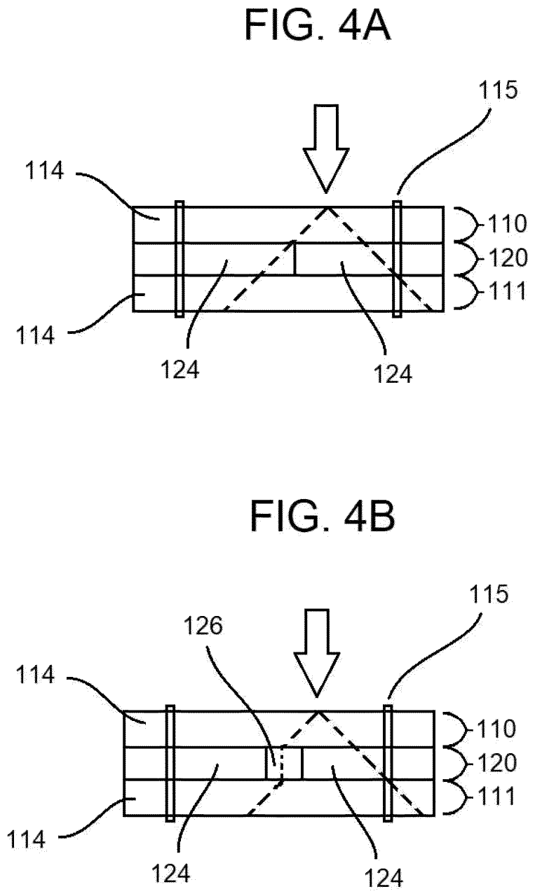

The second material of the inner layer(s) 120 may have both a lower density and a lower compressive strength than the first material of the outer layers 110 and 111. If the second material were loaded directly, e.g. if a truck were to drive over the second material, it would fail more quickly than the first material, for example by tearing or crushing. However, the second material can serve as the inner layer(s) 120 and support the outer layers 110, 111 without failing if the mat 10 is configured to predictably distribute a load. The mat 10 may be configured this way by building the inner layer(s) 120 with minimal voids 126 (illustrated in FIG. 4B), so that they are continuous material. For the purposes of this disclosure a “void” may be any gap in the inner layer(s) 120 between second planks 124 which is greater than a predetermined threshold size, for example 0.25 inches.

If the second material is extruded polypropylene or a similar foam, it can be manufactured with regular dimensions and straight lines without distorting over time like wood may, and may easily be cut into a desired shape after being manufactured. As a result, the second planks 124 of the inner layer(s) 120 may be more easily assembled than wood planks, allowing the mat 10 to use the first and second materials without requiring specialized facilities to assemble the different planks 114, 124 together. Furthermore, the second planks 124 may be placed edge-to-edge with minimal gaps or voids 126 between them, effectively making a continuous surface of the second material in the inner layer(s) 120. When the mat 10 is loaded, the force from the load may be spread out through the layers 110, 111, and 120. If all layers 110, 111, and 120 are in contact with each other, the load may spread out at approximately a 45-degree angle. This is illustrated in FIG. 4A, with the load illustrated as an arrow and its distribution through the layers 110, 120, 111 illustrated in dashed lines. If alternatively there is a void 126 between the planks 124 in the inner layer(s) 120, as illustrated for example in FIG. 4B, the load may be less predictably spread out, for example being transferred more directly through the layers and concentrating strain on the inner layers 120. If the strain is concentrated in this way, the inner layer(s) 120 may fail, e.g., tearing or crushing under the load. As such, having a continuous inner layer 120 may spread out loads as much as possible, reducing strain on the inner layer(s) 120. By reducing strain on the inner layer(s) 120 in this way, the second material may support the outer layers 110 and 111 without breaking, even if the second material has a lower compressive strength than the first material.

A foam used as the second material may include multiple small air pockets through its structure to lower its density. These air pockets may be smaller than the threshold size for a void 126. For example, the air pockets may be 0.125 inches or less in size. According to another exemplary embodiment of the present general inventive concept, the second material may include air pockets larger than the threshold size of a void 126, for example if the second material has a honeycomb structure. However, these air pockets are not located between individual planks 124, and are instead part of the structure of the second material, for example connected to adjacent air pockets to make up the structure of the second material. As such, the air pockets may be distinct from the voids 126. Furthermore, with such a structure including air pockets, the second material may have a lower density than the first material while still having enough structural strength to transfer and distribute a load as illustrated in FIG. 4A.

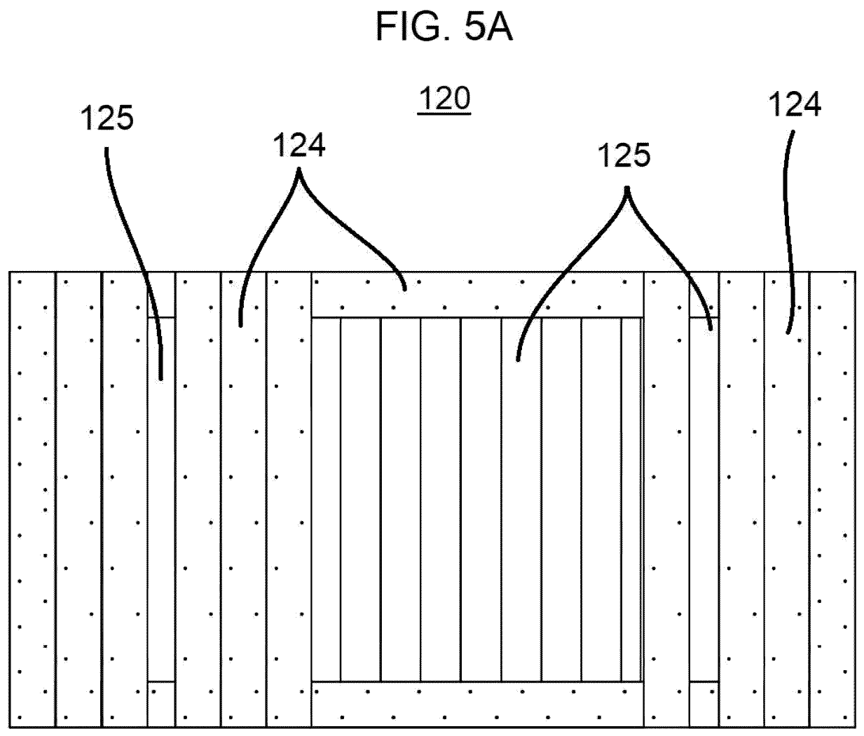

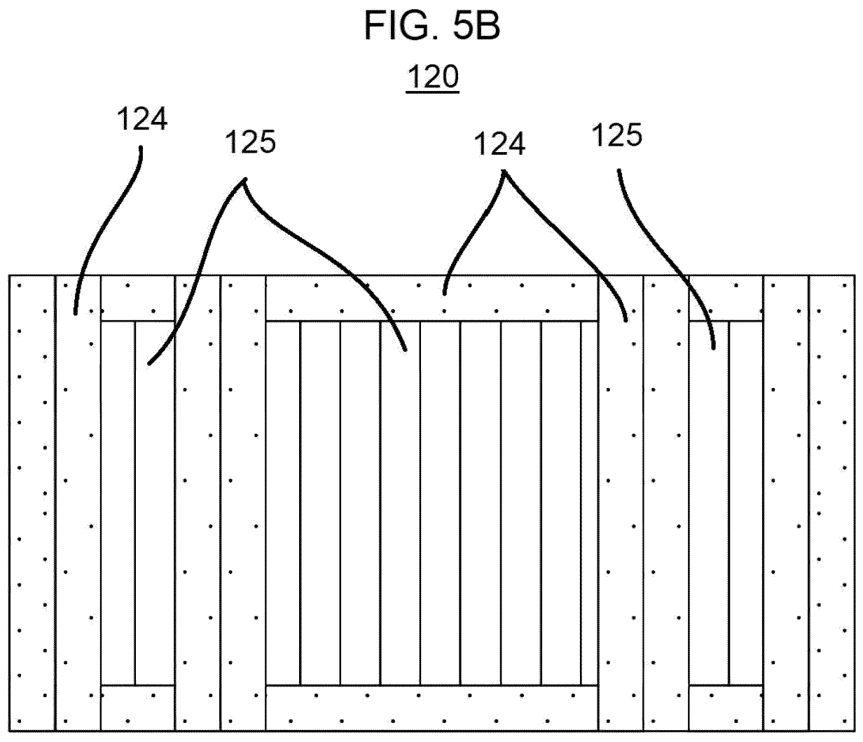

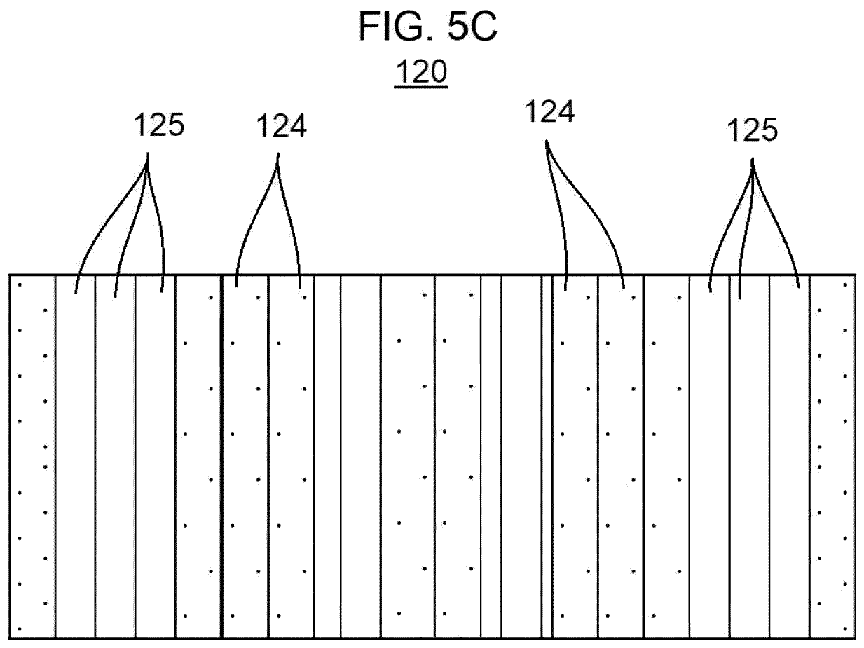

According to exemplary embodiments of the present general inventive concept the inner layer(s) 120 may be homogenous, i.e., made exclusively of one kind of material, or may be hybrid, meaning made of a plurality of different materials. FIGS. 5A-5C illustrate inner layers 120 made of hybrid materials according to exemplary embodiments of the present general inventive concept. As illustrated therein, an inner layer 120 may comprise both second planks 124 of the second material and third planks 125 of a third material. For clarity the fasteners 115 have been omitted from third planks 125 in FIGS. 5A-5C. However according to exemplary embodiments of the present general inventive concept fasteners 115 may extend through third planks 125.

According to exemplary embodiments of the present general inventive concept, the third material may have a third density which is greater than the second density, and may have a third compressive strength which is greater than the second compressive strength. According to exemplary embodiments of the present general inventive concept, the third material may be the same as the first material, e.g., wood. According to exemplary embodiments of the present general inventive concept, third planks 125 may be prepared with regular dimensions with minimal warping, so that they may be placed edge-to-edge with second planks 124 without generating voids 126 in the inner layer(s) 120. Third planks 125 may also have a thickness equal to that of second planks 124.

According to exemplary embodiments of the present general inventive concept, the third planks 125 may extend across the full width of the mat 10, as illustrated for example in FIG. 5C. According to other exemplary embodiments of the present general inventive concept, third planks 125 may extend less than a full width of the mat 10, as illustrated for example in FIGS. 5A-5B. As illustrated therein, ends of the third planks 125 of the third material may be covered behind second planks 124 of the second material. Some second planks 124 may be oriented perpendicular to other second planks 124 to cover the ends of the third planks 125. Covering the ends of third planks 125 with second planks 124 may help protect the ends of the third planks 125 and help keep them from absorbing water or mud from the surrounding environment.

A hybrid inner layer 120 may be constructed in anticipation of where a load will be applied to the mat 10. For example, third planks 125 of the denser material may be placed where they will support an expected load, e.g., the location of the tire of a truck that will drive over the mat 10, this weight being spread out as illustrated in FIG. 4A. In this exemplary embodiment, the second planks 124 of the second material may still be positioned edge-to-edge with third planks 125 to prevent voids 126 in the inner layer(s) 120 and ensure predictable load transfer through the mat 10.

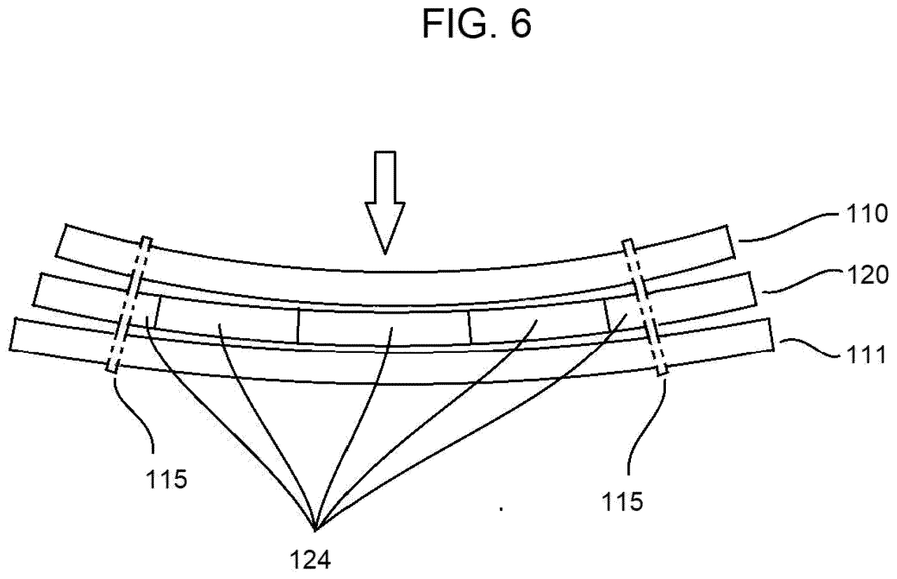

When the mat 10 is loaded with a weight, for example heavy equipment, the layers 110, 111, and 120 may be pressed together with the force. The force may cause the layers 110, 111, and 120 to deflect or bend. FIG. 6 illustrates a cross-sectional side view of a mat 10 under deflection according to an exemplary embodiment of the present general inventive concept. The degree of deflection, as well as the space between the layers 110, 120, and 111, is exaggerated in FIG. 6 for clarity. As illustrated therein, deflection of one layer may cause the other layers to deflect by a different amount. For example, if the mat 10 were loaded to cause the first outer layer 110 to deflect by a certain amount (load illustrated by an arrow in FIG. 6), the inner layer(s) 120 may deflect less, and second outer layer 111 may deflect even less. These different amounts of deflection can cause strain between the layers 110, 111, 120, especially around fasteners 115. According to exemplary embodiments of the present general inventive concept the layers 110, 111, and 120 may be configured to move relative to one another, allowing the layers 110, 111, and 120 to deflect by different amounts without building up strain. If inner layer(s) 120 may move along the fasteners 115, i.e., do not bond to the fasteners 115, then they can avoid building up strain around the fasteners 115 as well. Furthermore, if the inner layer(s) 120 are continuous, i.e., without voids 126, then the inner layer(s) 120 may predictably support the outer layers 110 and 111 during a deflection and spread out the force as described above and illustrated in FIG. 4A. If voids 126 were present in the inner layer(s) 120, strain may concentrate in the inner layer(s) 120 around such a void 126 during a deflection, causing the inner layer(s) 120 to fail as described above.

The inner layer(s) 120 may be used to control how much the mat 10 may deflect. By controlling the thickness and composition of inner layer(s) 120, e.g., controlling how many second planks 124 and third planks 125 are used and how many inner layers 120 are included, a mat 10 may be made with a predetermined amount of flexibility, and a resulting amount of deflection under a given load.

If the layers 110, 120, 111 were glued together such that they cannot move relative to one another, the mat 10 would effectively be a single layer the thickness of the whole mat 10. Such a “single layer” mat may be substantially less flexible, and able to deflect much less, than an exemplary embodiment of the mat 10 including layers 110, 120, and 111 which may move relative to one another. This lack of flexibility may reduce performance when the mat 10 is loaded. If the mat 10 is rigid, i.e., not flexible, then weight from a load may be evenly distributed over the entire area of the mat 10, which may push the edges of the mat 10 into the ground with the load. As a result, if the mat 10 is used over soft ground or mud, the mat 10 will be pushed deeper into the ground over time. As the edge of the mat 10 is pushed into the ground, it may begin “pumping,” a condition in which ground water flows over an upper surface of the mat 10, which can end up burying it in mud. A mat 10 that is buried in this fashion may absorb a great amount of water, and furthermore may be difficult to extract from the ground. Furthermore, if the ground is uneven, for example if there are rocks or tree stumps that the mat 10 is placed over, these uneven portions of the ground may become stress points on the mat 10. If the mat 10 is rigid, these stress points may concentrate force on parts of the mat 10, causing parts of the outer layers 110, 111 or inner layer(s) 120 to break when a load is applied to the mat 10. Still further, if the mat 10 is rigid, force may be concentrated on edges of the mat 10. For example, as equipment drives over a rigid mat 10, force on the edge of the mat 10 may push the edge down while causing the rest of the mat 10 to tilt upwards, such that the weight of mat 10 is concentrated on the edge, which may cause the edge to break.

Rather than being made rigid, according to exemplary embodiments of the present general inventive concept the mat 10 may be made with separate layers 110, 120, and 111 which may move relative to one another by a predetermined amount. This construction may give the mat 10 a predetermined degree of flexibility, such that it can deflect to accommodate imperfections in the ground, and furthermore to absorb a load moving over the mat 10. According to exemplary embodiments of the present general inventive concept, a flexibility of mat 10 may be limited to the point that the mat 10 may not deflect enough to damage its structural integrity, e.g., to the point that excessive shear stress is placed on the fasteners 115, or to the point that fasteners 115 are damaged and separate from the outer layers 110 and 111.

Low-density materials such as foam are often provided in large sheets for stability, since lower density materials are often fragile and likely to break. However, a solid sheet of a given material may be rigid, since any flexibility is limited by how much strain it can withstand without breaking. Furthermore, when a solid sheet of material breaks or fails, it can be unpredictable where the failure will occur, and such a failure means the structural integrity of the entire sheet is compromised, since a crack or other break may spread through the entire sheet. As a result, a mat that uses continuous sheets of material may have its structural integrity compromised if any of the sheets breaks or fails. In comparison, according to exemplary embodiments of the present general inventive concept the layers 110, 120, and 111 are made of first planks 114, second planks 124, and third planks 125 as opposed to unbroken solid sheets of any of the first, second, or third materials. The planks 114, 124, 125 may move relative to one another within a predetermined limit, allowing not just the layers 110, 120, 111 to deflect more easily relative to each other, but to allow deflection within a given layer more easily as well. Since two adjacent planks 114, 124, 125 may move relative to one another, they may deflect to different degrees without building up stress across an entire layer. As a result, planks 114, 124, 125 may prevent stress from concentrating in the mat 10 when it is deflects under a load. By preventing stress concentration, damage to any of the layers 110, 120, 111 can be prevented. Furthermore, if an individual plank 114, 124, or 125 breaks or fails, the other planks 114, 124, 125 may still be intact, preserving structural integrity of the mat 10.

According to an exemplary embodiment of the present general inventive concept, the flexibility of the mat 10 and degree to which the layers 110, 111, and 120 may move relative to one another, as well as the degree by which first planks 114, second planks 124, and third planks 125 may move relative to one another, may be adjusted by controlling the number of fasteners 115 used. According to an exemplary embodiment of the present general inventive concept a mat 10 that is 8 feet by 14 feet may use between 150 and 160 fasteners 115. According to an exemplary embodiment of the present general inventive concept, the fasteners 115 may be bolts or screws, and may be configured to allow the layers 110, 111, and 120 to move relative to one another by adjusting a tension in the bolts or screws, i.e., how tightly the fasteners 115 are screwed in place.

The dimensions of the mat 10 may also affect its flexibility. The larger a mat 10 is, the more flexible it becomes. Similarly, the thicker a mat is, the less flexible it is. To control the flexibility, larger mats 10 may include thicker inner layers 120 or additional inner layers 120, such that a larger mat 10 is thicker, to keep the overall flexibility of the mat 10 at a desired level. Conversely, a smaller mat 10 may include fewer or thinner inner layers 120 such that the mat 10 is thinner, while maintaining the desired flexibility. A smaller mat 10 may therefore be lighter, but more such mats 10 would be necessary for a given job, since smaller mats 10 necessarily cover less area. The specific dimensions of a mat 10 may be set based on the intended application, to balance the weight and size of individual mats 10 against how many mats 10 would be necessary for a given job. If the thickness of the mat 10 is predefined, for example to match the thickness of other mats already in use, then the flexibility of the mat 10 may still be adjusted by controlling the number and tightness of the fasteners 115, as well as the composition of the inner layer(s) 120, for example controlling what kind of material is used as the second or third material. A stiffer material as the second or third material, e.g., wood or aluminum instead of foam, may make the mat 10 less flexible as a result, and vice versa.

According to exemplary embodiments of the present general inventive concept, the second material may have a density between about 5% and about 50% of the density of the first material. If the inner layer(s) 120 are substantially the same size as inner layer(s) of a conventional mat, then the inner layer(s) 120 may have a total weight between about 5% and about 50% of the inner layer(s) of a conventional mat. As such, the total weight of a mat 10 according to exemplary embodiments of the present general inventive concept may be about 15% to about 40% less than the weight of a conventional mat. The total weight savings may depend on the number of inner layers 120 included and the composition of the inner layer(s) 120. In exemplary embodiments of the present general inventive concept including a single inner layer 120, the mat 10 may be between about 15% and about 32% lighter than a conventional mat of the same thickness. In exemplary embodiments of the present general inventive concept including a plurality of inner layers 120, the mat 10 may be up to 40% lighter than a conventional mat of the same thickness, because a greater proportion of the mat 10's total volume is made up of the relatively lighter inner layers 120, as compared to an exemplary embodiment including only one inner layer 120. As such, the weight savings may increase as the total thickness of the mat 10 increases. It will be understood that the specific percentages of weight reduction of mat 10 provided herein are examples, and are not intended to be limiting. Furthermore, since the inner layer(s) 120 may be significantly lighter, the outer layers 110, 111 may include denser, stronger materials such as oak or metal without making the mat 10 heavier than a conventional mat. As a result, the mat 10 may be stronger than if it were made exclusively of wood.

According to exemplary embodiments of the present general inventive concept, the second material of inner layer(s) 120 may have a density between about 65 kg/m³ and about 220 kg/m³, and the outer layers 110 and 111 may have a density between about 630 kg/m³ and about 1140 kg/m³. It will be understood that these numbers are only examples, and are not intended to be limiting.

According to exemplary embodiments of the present general inventive concept, the second material of the inner layer(s) 120 may have a lower puncture resistance relative to the first material of the outer layers 110, 111. For example, if the outer layer 110 were placed over an obstacle, such as a rock or a tree stump, when loaded with a weight, force may be concentrated at one point where the obstacle hits the layer 110. The first material of the outer layer 110 may distribute this concentrated force and maintain its structural integrity. In comparison, if the second material of the inner layer(s) 120 were placed directly over this same obstacle and loaded with a weight, the obstacle may damage or puncture the inner layer(s) 120. Accordingly, in operation the outer layers 110, 111 may distribute force over the inner layer(s) 120, as illustrated for example in FIG. 4A, so that force is not focused on one point of the inner layer(s) 120. The inner layer(s) 120 may therefore maintain structural integrity while supporting a load, for example if equipment is driven over the mat 10 while the mat 10 is on top of a tree stump or other obstacle.

According to exemplary embodiments of the present general inventive concept, the second material of the inner layer(s) 120 may have a compressive strength of about equal to or less than a compressive strength of the first material of the outer layers 110, 111. As non-limiting examples, the second material of the inner layer(s) 120 may have a compression modulus between about 4200 kPa and about 58,250 kPA, and a compression strength between about 272 kPA and about 3584 kPA when at 25% compression.

According to an exemplary embodiment of the present general inventive concept in which the inner layer(s) 120 have a compressive strength about equal to that of the outer layers 110, 111, the mat 10 may effectively function the same as though all layers 110, 111, and 120 were made of the same material. That is, the mat 10 may have similar deflection and load properties as a mat made exclusively of one kind of material, e.g., wood. According to other exemplary embodiments of the present general inventive concept, the inner layer(s) 120 may have a compressive strength less than that of the outer layer 110, 111. However, as described above with reference to FIG. 4A, the inner layer(s) 120 may still support and stiffen the outer layers 110, 111 if loads a predictably distributed through the mat 10.

According to exemplary embodiments of the present general inventive concept, the outer layers 110, 111 and inner layer(s) 120 may each have a predetermined degree of flexibility. According to exemplary embodiments of the present general inventive concept, the inner layer(s) 120 may have a flexibility and elasticity greater than the outer layers 110, 111. The flexibility of the inner layer(s) 120 may be such that the mat 10 may deflect a predetermined amount when loaded with weight, and resume its original shape when the weight is removed. According to exemplary embodiments of the present general inventive concept, the second material of the inner layer(s) 120 may have a flexural strength, or modulus of rupture, between about 1475 kPA and about 3430 kPA at a temperature of 24 degrees Celsius. It will be understood that these numbers are non-limiting examples of flexural strength of the inner layer(s) 120.

In operation the outer layers 110, 111 and inner layer(s) 120 may support one another. The outer layers 110, 111 may serve as contact surfaces for the ground and for equipment, distributing force applied to the mat 10 over the inner layer(s) 120. The inner layer(s) 120 may add strength and rigidity to the outer layers 110, 111 to prevent them from deflecting excessively when a load is placed on the mat 10. The inner layer(s) 120 may furthermore transfer a load on the mat 10 between the outer layers 110, 111, allowing a load to be transferred to the ground and distributed over the area of the mat 10. The inner layer(s) 120 may deflect or compress when a load is placed on the mat 10, but the inner layer(s) 120 may have an elasticity that allows them to resume their original shape and cross-section after a load is removed from the mat 10.

Furthermore, because the second material of the inner layer(s) 120 may be water-resistant, the inner layer(s) 120 may stay dry even after being used in wet environments such as mud or standing water. As such, the inner layer(s) 120 may absorb little to no water and soil during use. According to exemplary embodiments of the present general inventive concept, the second material of the inner layer(s) 120 may have a water absorption of between about 0.09 and about 2.97 kg/m². It will be understood that these numbers are provided as non-limiting examples. Still further, if the inner layer(s) 120 are constructed with minimal voids 126, then there are less spaces for water or mud to collect in, which prevents the mat 10 from taking on additional weight.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A mat, comprising:
a first outer layer comprising a plurality of first planks, the first planks comprising a first material having a first compressive strength and a first density;
a second outer layer comprising a plurality of the first planks;
at least one inner layer comprising a plurality of second planks disposed between the first and second outer layers, the second planks being disposed edge-to-edge next to each other, the second planks comprising a second material having a second compressive strength and a second density, the second density being lower than the first density; and
a plurality of fasteners extending through the first outer layer, the at least one inner layer, and the second outer layer at predefined points.

2. The mat of claim 1, wherein the first outer layer, the second outer layer, and the at least one inner layer are configured to move relative to one another within a predefined limit.

3. The mat of claim 1, wherein the second planks are configured to move relative to each other within a predefined limit.

4. The mat of claim 1, wherein the at least one inner layer has a greater flexibility than the first outer layer or the second outer layer.

5. The mat of claim 1, wherein the second material is water-resistant.

6. The mat of claim 1, wherein the second compressive strength is less than the first compressive strength.

7. The mat of claim 1, wherein the second compressive strength is about equal to the first compressive strength.

8. The mat of claim 1, wherein the second density is between about 5 percent and about 50 percent of the first density.

9. The mat of claim 1, wherein the plurality of second planks is configured to avoid bonding with plurality of fasteners.

10. The mat of claim 9, wherein the plurality of second planks is configured to move along a length of the plurality of fasteners.

11. The mat of claim 1, wherein the first outer layer, second outer layer, and at least one inner layer each have a predefined degree of flexibility.

12. The mat of claim 1, wherein the second layer further comprises one or more third planks comprising a third material, the third material having a third compressive strength and a third density, the third density being greater than the second density.

13. The mat of claim 12, wherein the third material is identical to the first material.

14. A method of constructing a mat, the method comprising:
providing a first outer layer comprising a plurality of first planks, the first planks comprising a first material having a first compressive strength and a first density;
providing a second outer layer comprising a plurality of the first planks;
providing at least one inner layer comprising a plurality of second planks disposed between the first and second outer layers, the second planks being disposed edge-to-edge next to each other, the second planks comprising a second material having a second compressive strength and a second density, the second density being lower than the first density; and
inserting a plurality of fasteners through the first outer layer, the at least one inner layer, and the second outer layer at predefined points.

15. The method of claim 14, further comprising adjusting a flexibility of the mat by adjusting a tension in one or more of the plurality of fasteners.

16. The method of claim 14, further comprising adjusting a flexibility of the mat by adjusting a thickness of the at least one inner layer.
